(19) United States
(12) Patent Application Publication
(10) Pub. No.: US 2006/0077486 A1
(43) Pub. Date: Apr. 13, 2006

(54) Printer with control box

(75) Inventors: Jose de Jesus Manrique Lizarraga, Helmond (NL); Hans Wierink, Maasbree (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/245,178

(22) Filed: Oct. 7, 2005

(30) Foreign Application Priority Data
Oct. 8, 2004 (EP) 04104939.6

(51) Int. Cl. G06F 3/12

(52) U.S. Cl. 358/498; 358/1.15

(57) ABSTRACT

A printer having a bridge-like frame structure with two upright members and a cross-member, and functional components mounted to the frame structure and connected to control circuitry, wherein the control circuitry is accommodated in a central control box that has a top access opening and is pivotally mounted between the upright members and underneath the cross-member so as to be tiltable into a position exposing the access opening.

### BACKGROUND OF THE INVENTION

The present invention relates to a printer having a bridge-like frame structure with two upright members and a cross-member, and functional components mounted in the frame structure and connected to control circuitry.

An example of a printer with such a construction is an ink jet printer having a carriage carrying ink jet printheads and arranged to move back and forth along the cross-member so as to print an image on a sheet of a recording medium that is advanced over a sheet support plate witch is an essential part of the cross-member. The recording media may be provided as endless webs that are drawn from reels, the reels being rotatably supported between the upright members in the lower part of the frame structure.

The printer has a number of functional components, such as the printheads, a carriage drive system, a sheet advance mechanism, cutting mechanisms for cutting the recording medium to a desired length, a vacuum system for creating a suction pressure for holding the recording medium flat on the sheet support plate, a temperature control system for controlling the temperature of the sheet support plate, for example, when the printer operates with hot-melt ink, a discharge mechanism for discharging the printed sheets, a control panel for entering print instructions, and the like. The various functional components are connected to control circuitry including electronic control units arranged on printed circuit boards or the like for controlling the functions of the various components. The control circuitry is not limited to electronic circuitry but may, for example, also include pneumatic control circuits.

### SUMMARY OF THE INVENTION

It is an object of the present invention to provide a printer which has a compact construction and nevertheless permits easy access to the control circuitry for maintenance purposes and the like.

According to the present invention, this object is achieved by a printer of the type indicated above, in which the control circuitry is accommodated in a central control box that has a top access opening and is pivotally mounted between the upright members and underneath the cross-member so as to be tilted into a position exposing the access opening.

Thus, in the normal condition of the printer, i.e., a condition in which the printer is ready to operate, the central control box accommodating the control circuitry or at least a major part thereof is arranged in a space-saving manner right underneath the cross-member. This, however, has the consequence that the top access opening of the control box is at least partially blocked by the cross-member. In order to permit access to the various control units in the control box, the latter is tilted into an inclined position, so that the access opening is moved away from the cross member and may readily be accessed from the front side or the back side of the printer.

This construction has the remarkable advantage that practically the entire area of the cross member, when seen in plan view, may be utilised for mounting a control box with relatively large dimensions and a correspondingly large top opening, so that a large number of control units may be arranged in a concise manner in one and the same control box. Thus, in case of maintenance or repair, the service engineer simply has to tilt the control box into the inclined position in order to obtain easy access to the control units for most or even all of the functional components of the printer. The pivotal arrangement of the control box has the further advantage that the box may be moved from the normal position to the exposed position without requiring a substantial extra length for the cables, hoses and the like connecting the functional components of the printer to the respectively associated control units.

The present invention is particularly useful for a printer having a modular construction in which functional components may be added or changed in order to meet the specific demands of the customers. When, for example, the functionality of a specific functional component needs to be altered, the control circuitry may easily be accessed by opening the control box and replacing the pertinent control unit by another one which implements the desired functions. Similarly, if a control unit or the control circuitry as a whole has a defect that cannot be diagnosed and/or repaired on the spot, it is a simple matter to remove the pertinent control unit or even the control box as a whole and to replace it by a new one while the defective unit or control box is shipped to the manufacturer for repair.

### BRIEF DESCRIPTION OF THE DRAWINGS

The present invention will now be described in conjunction with the following drawings, wherein:

FIG. 1 shows a schematic perspective view of an ink jet printer according to the present invention with a control box in an operating position;

FIG. 2 shows the printer of FIG. 1 with the control box in a maintenance position; and

FIGS. 3 to 5 show detailed perspective views of a mounting structure for the control box in different positions.

### DETAILED DESCRIPTION OF THE INVENTION

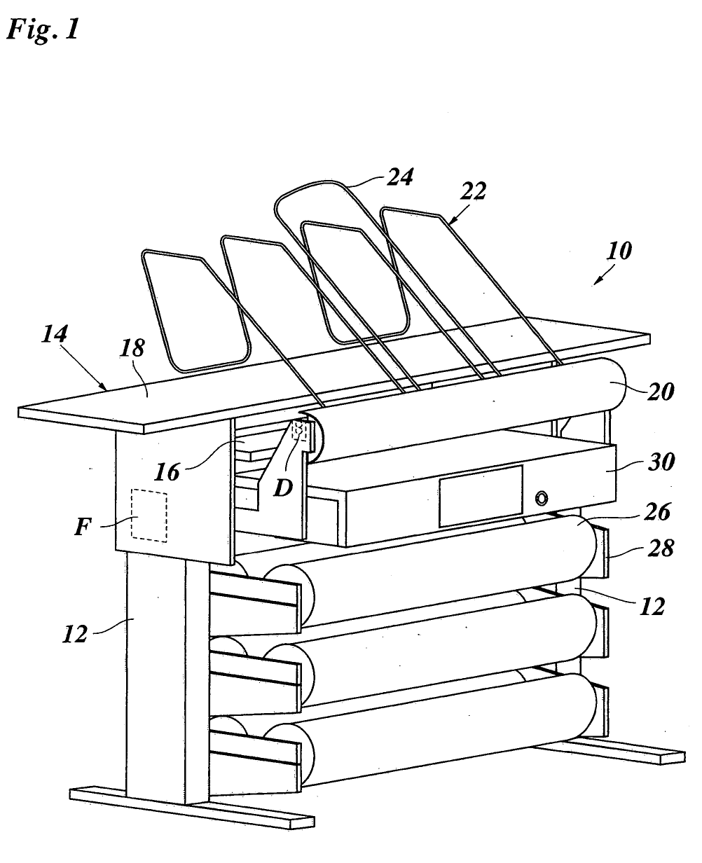

As is shown in FIG. 1, an ink jet printer includes a bridge-like frame structure which is essentially formed by two upright members and a cross-member interconnecting the top ends of the upright members.

The cross-member includes a substantially horizontal sheet support plate and a sub-frame 18 arranged above the sheet support plate for supporting and guiding a carriage (not shown) which carries a number of ink jet printheads and is moved back and forth between the upright members 12 so as to print an image on a sheet of a recording medium that is advanced over the sheet support plate 16. A sheet discharge mechanism D is arranged at a downstream end of the sheet support plate 16 and comprises an arcuate guide member 20 for upwardly deflecting and reversing a printed sheet which will eventually be discharged in an upwardly inclined tray 22. In the example shown, the tray 22 is formed by appropriately bent metal bars 24 and is adapted to accommodate, for example, printed sheets of various sizes ranging from A4 portrait to A0 landscape.

Sheets of recording media of different types may be drawn off from reels 26 that are rotatably supported in three drawers 28 disposed between the upright members 12 in the lower part of the frame structure 10. A feed mechanism F is mounted in the frame structure for feeding a web of recording medium from a selected one of the reels 26 towards the upstream end of the sheet support plate 16 and past a cutting mechanism (not shown) for cutting the web to a desired sheet length.

It is observed that FIG. 1 shows the printer from the back side, so that the front side or operating side of the printer is the side facing away from the viewer in FIG. 1. In order to replace a reel 26 that has become exhausted, the drawers 28 may be drawn-out towards the operating side of the printer.

A space between the bottom side of the cross-member 14 and the top one of the drawers 28 is occupied by a rectangular control box 30 that accommodates essentially all the control units and circuitry needed for controlling the various functional components of the printer, such as the printheads, the feed mechanism F, the discharge mechanism D and the like. The control box 30 spans almost the entire interval between the two upright members 12 and is disposed with a slight vertical clearance underneath the sheet support plate 16. The length of the control box 30 (in the direction perpendicular to the cross-member 14) is approximately equal to the length of the sheet support plate 16, including the guide member 20 of the sheet discharge mechanism.

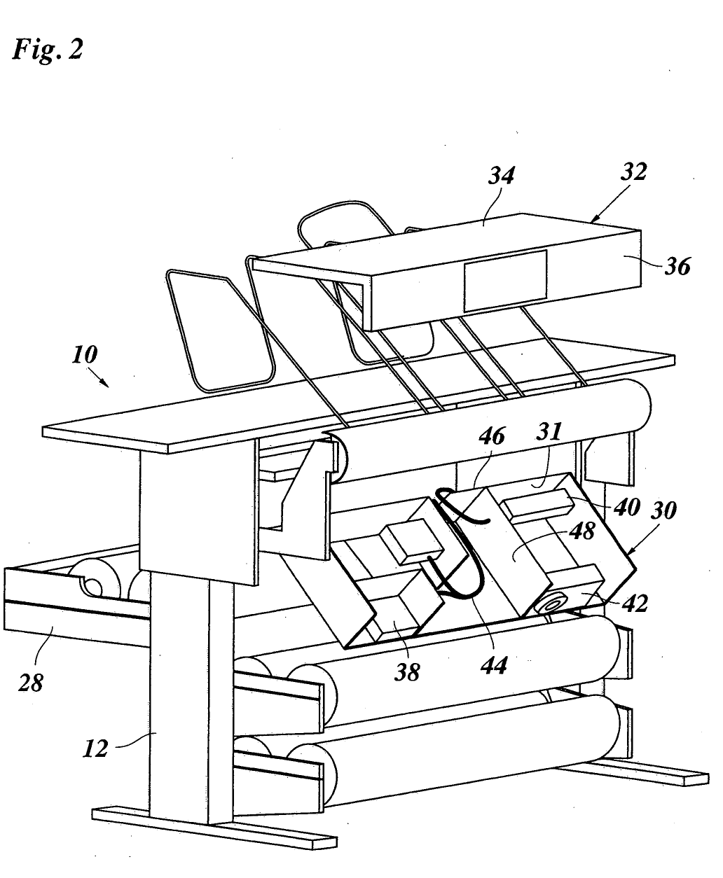

When a service engineer needs to get access to one or more of the control units in the control box 30, for the purpose of maintenance, diagnosis or repair or for exchanging or adding a control unit, the top drawer 28 is drawn out towards the operating side of the printer, so as to enlarge the free space underneath the rear end of the control box 30, as is shown in FIG. 2. The control 30 is pivotally supported in the frame structure 10 and has a pivotal axis extending horizontally near the front bottom edge of the control box. In FIG. 2, the control box has been tilted about this pivotal axis by an angle of approximately 45° so as to expose a large access opening 31 at the top and rear sides of the control box. A lid 32 forming a top wall 34 and a rear wall 36 of the control box has been removed, so that the interior of the control box is readily accessible for the service engineer. A number of electronic control units 38 for the various functional components of the printer are schematically shown in FIG. 2. The control box 30 also includes power supply units 40, blowers 42 and the like. Cables 44 connecting the control units 38 to the functional components respectively associated therewith are fed-out through an opening in the front wall 46 of the control box. Since this opening is disposed in the vicinity of the pivotal axis of the control box, the required length of cables is practically not affected by the tilt position of the control box. As is further shown in FIG. 2, the interior of the control box 30 is divided into several compartments by means of separating walls 48, so that the control units and other components of the control circuitry may be arranged in the control box 30 in a well organised and concise manner, with heat sensitive components being shielded from heat generating components.

It will be understood that the cables 44 are connected to the control units 38 through plug connectors which have not been shown in detail, so that the various units accommodated in the control box 30 may easily be disconnected and removed, if necessary.

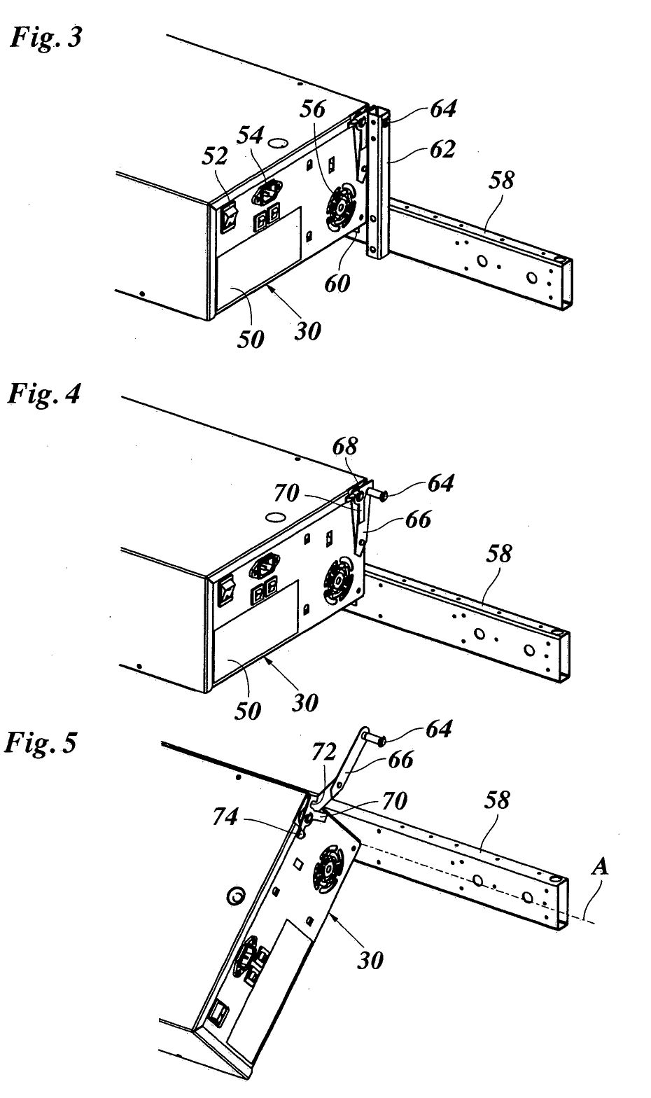

FIGS. 3 to 5 show an example of a mounting structure for pivotally mounting the control box 30 in the frame structure 10. FIG. 3 shows one end of the control box 30 in the operating state (as in FIG. 1). This end of the control box is closed-off by an end wall 50 including switches 52, a main power connector 54, a grid 56 for a blower, and the like. The lower front edge of the control box 30 is pivotally supported at a crosspiece 58, e.g., by means of hinges 60 only a small part of which is shown in FIG. 3. The crosspiece 58 is connected between the upright members 12 of the frame structure and carries a vertical post 62 which has a horizontally projecting pin 64 at its top end.

In FIG. 4, the post 62 has been removed, so that the pin 64 can be seen more clearly. An articulated link 66 is disposed in parallel with the end wall 50 of the control box and has one end rotatably connected to the pin 64 and the other end connected to a pivot 68 projecting outwardly from the top edge of the end wall 50. A T-shaped hook member 70 is rotatably supported on the same pivot 68.

As can be seen more clearly in FIG. 5, one end of the cross-bar of the T-shaped hook member 70 forms a hook 72, and the opposite end forms a tab 74 serving a manual grip. In the condition shown in FIGS. 3 and 4, the hook 72 engages the pin 64, so that the control box 30 is arrested in its horizontal position. When a user or a service engineer wishes to tilt the control box 30 into the inclined position shown in FIG. 2, he depresses the tab 74 with his finger, so that the hook member 70 rotates about the pivot 68, and the hook 72 is released from the pin 64. Then, the control box 30 can be tilted about its pivotal axis A, as is indicated in FIG. 5. The control box 30 is arrested in the inclined position when the articulated link 66 reaches a substantially stretched condition. A stop (not shown) at one of the two members of the articulated link 66 prevents the same from reaching a fully stretched dead-center position, so that the link will yield again when the opposite ends thereof are pushed together.

The hook member 70 may be biased towards its engaging position (clock-wise in FIG. 5) by means of a coil spring or the like. When the user wishes to return the control box 30 to the horizontal position, he tilts the control box upwardly and depresses the tab 74 with a finger. By the end of the upward tilt movement, the vertical leg of the hook member 70 will abut at the pin 64, and this will cause the hook member to rotate clock-wise, so that the pin 64 is again engaged by the hook 72, when the user releases the tab 74.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A printer having a bridge-like frame structure with two upright members and a cross-member, and functional components mounted to the frame structure and connected to control circuitry, wherein the control circuitry is accommodated in a central control box that has a top access opening, said control box being pivotally mounted between the upright members and underneath the cross-member so as to be tiltable into a position exposing the access opening.

2. The printer according to claim 1, wherein a drawer is disposed underneath the control box such that, when the drawer is drawn out, the control box is tiltable into a space that had been occupied by the drawer.

3. The printer according to claim 2, wherein the drawer accommodates a reel (26) for an endless web of a print medium.

4. The printer according to claim 1, wherein the control box spans substantially the whole width between the two upright members.

5. The printer according to claim 1, wherein the top access opening of the control box extends over at least a major part of a top surface and a side surface of the control box opposite to the side where a pivotal axis of the control box is located, and the access opening is covered by a removable lid.

6. The printer according to claim 1, wherein the control box has a pivotal axis extending near a lower edge thereof.

7. The printer according to claim 6, wherein a lower edge of the control box is hinged to a member of the frame structure, and an upper edge of the control box on the side that is hinged to said member is connected to the frame structure by an articulated link.

8. The printer according to claim 7, wherein the articulated link is disposed outside of and in parallel with an end wall of the control box and has one end rotatably connected to a horizontally projecting pin fixed to the frame structure, and a hook member is rotatably supported at the same end wall of the control box and engages said pin to hold the control box in its non-tilted position.

9. The printer according to claim 8, wherein the hook member has a T configuration having a cross-bar, the central portion of which is rotatably supported on a pivot which rotatably supports also one end of the articulated link, one end of the cross-bar forming a hook for engaging the pin and the opposite end of the cross-bar forming a tab for releasing the hook from the pin, the vertical leg of the T-shaped hook member serving as an abutment for the pin.

10. The printer according to claim 1, wherein said printer is an ink jet printer.
